(19) United States
(12) Patent Application Publication
(10) Pub. No.: US 2024/0202508 A1
(43) Pub. Date: Jun. 20, 2024

(54) HYPERUNIFORM AND NEARLY HYPERUNIFORM NEURAL NETWORKS

(71) Applicant: International Business Machines Corporation, Armonk, NY (US)

(72) Inventors: Fausto Martelli, Stockton Heath (GB); Bruce Gordon ELMEGREEN, Goldens Bridge, NY (US); MALGORZATA JADWIGA ZIMON, Warrington (GB); Kyong Min Yeo, Scarsdale, NY (US)

(21) Appl. No.: 18/085,555

(22) Filed: Dec. 20, 2022

(51) Int. Cl. G06N 3/0499

(52) U.S. Cl. CPC G06N 3/0499

(57) ABSTRACT

A sparse topology for a feedforward neural network is generated, where connectivity is based on a substantially hyperuniform topology. The feedforward neural network with the sparse topology is trained using a set of training data and a processing task is performed using the trained feedforward neural network.

### BACKGROUND

The present invention relates generally to the electrical, electronic and computer arts and, more particularly, to machine learning systems.

A long range order, known as nearly hyperuniformity (NH), has recently been found in many natural systems. Examples of NH order are the arrangement of visual cones in birds' eyes, the distribution of the cosmic background radiation in the early universe, prime numbers and amorphous materials. The reason for nature to arrange itself in these patterns is that NH distributions efficiently suppress large-scale density fluctuations, such as in crystals, which are perfect hyperuniform structures, while occupying less space. Hyperuniform structures, e.g., honeycomb patterns, are found to enable the network of visual cones to efficiently process information in bugs' eyes. Therefore, nature found both hyperuniform and nearly hyperuniform orders to be optimal configurations for maximal packing in which the smallest number of computing cells can perform a particular task.

### BRIEF SUMMARY

Principles of the invention provide hyperuniform and nearly hyperuniform neural networks. In one aspect, an exemplary method includes the operations of generating a sparse topology for a feedforward neural network, where connectivity is based on a substantially hyperuniform topology; training the feedforward neural network with the sparse topology using a set of training data; and performing a processing task using the trained feedforward neural network.

In one aspect, a non-transitory computer readable medium comprises computer executable instructions which when executed by a computer cause the computer to perform the method of generating a sparse topology for a feedforward neural network, where connectivity is based on a substantially hyperuniform topology; training the feedforward neural network with the sparse topology using a set of training data; and performing a processing task using the trained feedforward neural network.

In one aspect, an apparatus comprises a memory and at least one processor, coupled to the memory, and operative to perform operations comprising generating a sparse topology for a feedforward neural network, where connectivity is based on a substantially hyperuniform topology; training the feedforward neural network with the sparse topology using a set of training data; and performing a processing task using the trained feedforward neural network.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
a neural network with a hyperuniform or nearly hyperuniform topology;
improve the technological process of performing complex tasks, e.g., regression and classification, important for computer vision, computerized speech recognition, and machine translation;
a lower loss error with the disclosed hyperuniform neural network (also referred to as an HNN herein) than a fully-connected neural network with comparable (or higher) number of weights to be optimized;
a hyperuniform neural network that is more stable than a fully-connected neural network;
a hyperuniform neural network that has a lower variance than a fully-connected neural network;
a nearly hyperuniform neural network (also referred to as an NHNN herein) that is more stable and has a lower variance than a fully-connected neural network; and
a hyperuniform neural network that may perform better than a neural network with maximum pruning or minimum pruning, particularly for deeper networks.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a graph of the relationship between the radius of observation window, R, and variance, σ² (R), for a given dimension d, in accordance with an example embodiment;

FIG. 2 shows a schematic representation of a two-dimensional nearly hyperuniform neural network with three input nodes and three output nodes;

FIG. 3 shows a section of a hyperuniform neural network with three input nodes, in accordance with an example embodiment;

FIG. 4 shows a section of a nearly hyperuniform neural network with three input nodes, in accordance with an example embodiment;

FIG. 5A is an example of a hyperuniformly connected network, in accordance with an example embodiment;

FIG. 5B illustrates a fully-connected neural network undergoing pruning (dashed lines) to generate a (nearly) hyperuniform network, in accordance with an example embodiment;

FIG. 6A is a flowchart for generating a hyperuniform neural network, in accordance with an example embodiment;

FIG. 6B is high-level computer code for generating a hyperuniform neural network, in accordance with an example embodiment;

FIG. 7 shows the results of a regression task, in accordance with an example embodiment;

FIG. 8 shows the results of applying a trained filter to a noisy signal, in accordance with an example embodiment;

FIGS. 9A-9D are graphs of prediction error vs. the number of weights to optimize with a Tanh activation for a fully-connected neural network, a hyperuniform neural network, and a one layer neural network, in accordance with an example embodiment;

FIG. 10 is a plot of the 95% and 85% percentile range for fully-connected and hyperuniform networks based on ensemble of 100 models (after 400 epochs);

FIG. 11 is a graph showing a comparison of the relative error obtained with the hyperuniform model and with 100 networks randomly pruned and without dead nodes, in accordance with an example embodiment;

FIG. 12 shows the relative error obtained from sparse models with less and more connections than the hyperuniform architecture; and

FIG. 13 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

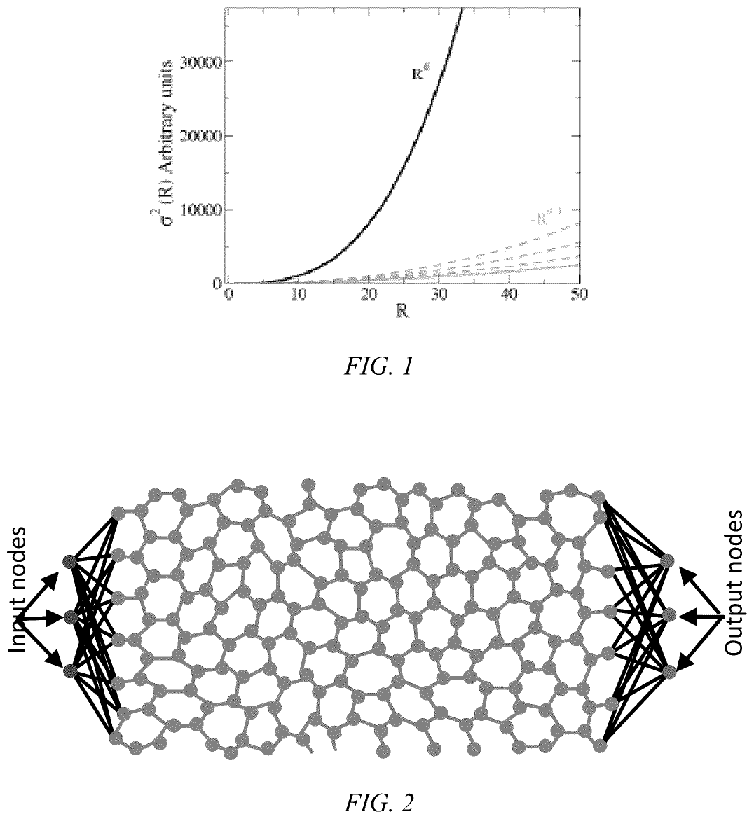

Generally, a neural network architecture is provided in which nodes are connected in a nearly hyperuniform or hyperuniform manner for learning. “Hyperuniform” and “nearly hyperuniform” are used herein with their common and ordinary meaning, as would be understood by the skilled artisan. In particular, as used herein, “hyperuniform” refers to the suppression of long-range density fluctuations, “nearly hyperuniform” refers to the near suppression of long-range density fluctuations, and “substantially hyperuniform” refers to both “hyperuniform” and “nearly hyperuniform” density fluctuations. See also further discussion of “nearly” hyperuniform network with respect to FIG. 1 below. From a technological perspective, NH distribution of points has paved the way to the discovery of novel materials with tunable photonic band gaps. A pertinent aspect for achieving such configurations lies in the network of bonds connecting each atom. The network of bonds typically needs to respect certain constraints, such as perfect coordination, limited variance of angular distributions, and the like. In one example embodiment, a nature-inspired neural network architecture with such NH node connectivity is disclosed. In the same way as birds' eyes provide higher resolution with the smallest number of cones, NH networks allow photons to travel in otherwise insulating materials, and hyperuniform arrangements to process information in bugs' eyes, one or more exemplary disclosed hyperuniform neural networks (HNNs) and nearly hyperuniform neural networks (NHNNs) capture nonlinearities while reducing potential challenges, such as overfitting and high training cost. We have found that, by constraining the arrangement of learning units to maximal packing order, an HNN and an NHNN can learn more efficiently than a classical fully connected approach.

FIG. 1 is a graph of the relationship between the radius of observation window, R, and variance, σ²(R), for a given dimension d. In a Poisson distribution, the variance grows with the power d of the radius R (top solid continuous line), while for nearly hyperuniform distributions (dashed lines), the variance grows close to the power d−1 of the radius R, namely between d and d−1. In the case of perfect hyperuniformity, like in a crystal, the variance grows exactly with the power of d−1. Hyperuniform order can be easily detected at small scales. On the other hand, it has been shown that order in NH patterns is distinguishable from random distributions at larger scales (see, FIG. 1). Therefore, the NHNNs may have the ability to perform better for very deep learning tasks. Thus, in a d-dimensional space, a nearly hyperuniform network is a network in which the number variance grows with a power between d and d−1. Another mathematical definition is the following: compute the parameter H defined as S(k=0)/S(k_max), where S(k=0) is the structure factor extrapolated at the origin and S(k_max) is the structure factor at the highest intensity peak. Nearly hyperuniform networks occur when H<10-3.

Furthermore in this regard, in one or more embodiments, it is appropriate to generate a material in which the connectivity of bonds is nearly hyperuniform, and to map that nearly hyperuniform topology in a neural network. One way to generate a material with nearly hyperuniform connectivity is, e.g., via the Wooten-Winer-Weaire algorithm, or via molecular dynamics simulations, as discussed below.

Structures with hyperuniform and nearly hyperuniform connectivity can be high-dimensional. Examples are crystals and glassy water in which each node has four links, but the theory of hyperuniformity and nearly hyperuniformity is valid in higher dimensions. For simplicity, in one example embodiment, a two-dimensional network is focused on. FIG. 2 shows a schematic representation of a two-dimensional nearly hyperuniform neural network with three input nodes and three output nodes. The hidden NHNN includes an actual network of silicon atoms in a photonic amorphous material. In this case, each node establishes three connections. The exact geometry of such a network will be mapped directly from the systems observed in nature. The protocol for generating these neural networks may employ, for example, Delaunay's triangulating the hyperuniform point pattern. Another exemplary approach includes directly mimicking structures that have bonds, such as molecular water or silicon systems modelled by the well-known Wooten-Winer-Weaire algorithm. At first sight, the connection of neurons in NHNNs can resemble the well-known Boltzmann Machine, which is a generative unsupervised model with bidirectional neurons fully connected to all other units. However, the NHNN introduces more restrictions on the connectivity which mimics what happens in observed physical systems.

There are multiple possible training strategies that can benefit from NH connectivity. In one example embodiment, an exemplary procedure is described that performs learning in a similar fashion to a feedforward network. It is noted that methods applied to graph neural networks would also be suitable in this setting.

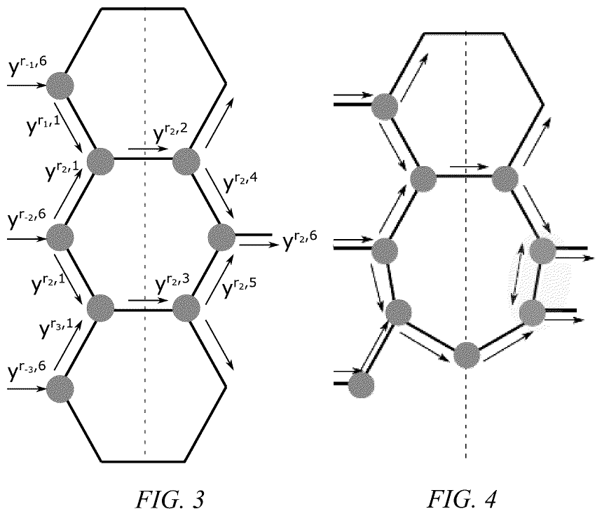

FIG. 3 shows a section of a hyperuniform neural network with three input nodes, in accordance with an example embodiment. FIG. 4 shows a section of a nearly hyperuniform neural network with three input nodes, in accordance with an example embodiment. The dashed lines separate proposed layers and arrows denote the direction of information flow in a ring. In FIG. 3, the negative superscript for the outputs, y^{r}^{_{−n}}^{,u}, suggests that the information is provided from the previous rings. FIG. 4 presents a case with an uneven number of nodes in the rings, where bidirectional connections may be allowed. It is noted that, firstly, elements of an input vector are fed into the first set of hidden nodes marked with orange circles. Then, each unit applies a linear transformation to the input element (or vector). Finally, the unit applies an activation function to the result of the linear transformation and obtains the output value, a real number. Here, a notion of a layer can be understood as a set of nodes connected in one direction (as denoted with a dashed line). The output value of a unit of some layer, l, becomes an input value of the subsequent unit(s) of the same or a different layer. Nodes in the same layer may have the same activation function, g^{(l)} Another order is also recognized, which is a local pattern (a ring). A copy of information flows over the top and through the bottom of each ring to meet at the rightmost corner of the pattern (as shown with arrows in FIG. 3). Each unit has its parameters w^{r}^{ₙ}^{,u}, b^{r}^{ₙ}^{,u}, where u is the index of the node, and r₁, . . . , rₙ is the index of a local pattern (ring). Weights w can be a vector (marked bold) if the received input is a vector. The output of each unit is denoted as y^{r}^{ₙ}^{,u}. In FIG. 3, a hyperuniform section of the network (with a uniform number of nodes) is considered where the input information is an output from previous rings. Looking at FIG. 4, it is noted that in a nearly hyperuniform setting, rings can have a different number of nodes. Therefore, an additional constraint should be introduced. FIG. 4 showcases a potential introduction of bidirectional connections with exchange of information between the highlighted nodes. This allows for a mixing of information that can reach different regions of the network. Another option is to skip the connection and allow the information to move directly to a new ring without the exchange between highlighted nodes. In the simplified setting of FIG. 3 (with the same number of nodes in neighboring rings), the following outputs are constructed:

$${y}^{{r}_{1} , 1} = {g}^{( 1 )} ( {w}^{{r}_{1} , 1} {y}^{{r}_{- 1} , 6} + {b}^{{r}_{1} , 1} ) ,$$

$${y}^{{r}_{2} , 1} = {g}^{( 1 )} ( {w}^{{r}_{2} , 1} {y}^{{r}_{- 2} , 6} + {b}^{{r}_{2} , 1} ) ,$$

$${y}^{{r}_{2} , 2} = {g}^{( 1 )} ( {w}^{{r}_{2} , 2} [ \begin{matrix}{y}^{{r}_{1} , 1} \\ {y}^{{r}_{2} , 1}\end{matrix} ] + {b}^{{r}_{2} , 2} ) ,$$

$${y}^{{r}_{2} , 4} = {g}^{( 2 )} ( {w}^{{r}_{2} , 4} {y}^{{r}_{2} , 2} + {b}^{{r}_{2} , 4} ) ,$$

$${y}^{{r}_{2} , 6} = {g}^{( 2 )} ( {w}^{{r}_{2} , 6} [ \begin{matrix}{y}^{{r}_{2} , 4} \\ {y}^{{r}_{2} , 5}\end{matrix} ] + {b}^{{r}_{2} , 6} ) .$$

To solve a regression or a classification problem, the last (the rightmost) layer of the neural network may contain unit(s) with linear activation for regression or logistic function for binary classification. Any activation function can be chosen, assuming it is differentiable. The values of the parameters can be updated through backpropagation which computes gradients using the chain rule. During gradient descent, the neural network's parameters receive an update proportional to the partial derivative of the cost function with respect to the current parameter in each iteration of training.

Looking at the equations above, it is noted that the number of calculations needed can be much lower than what is required to train a standard fully connected network. A starting point for networks with one-to-all connections is (L−1)n*n, where n is the number of nodes per layer and L is the number of layers. In the case of the NHNN shown in FIGS. 3 and 4, each unit has three connections, so the total number of connections is 3N/2 for a number of nodes N; the computation load scales with 1.5N also. Considering n=N/L nodes per layer with L layers, this is 1.5Ln, smaller than for a conventional NN if n is large. The number of calculations becomes about the same if the number of layers in the NHNN equals the number of input nodes, n, which may be necessary to propagate all the input information to all of the nodes in at least one layer, and the number of layers in the conventional NN is small. Nonetheless, it should be noted that a given number of nodes can be adjusted in several possible NH configurations. Therefore, the exact number of operations depends on the network connectivity, as well as on the dimensionality of the network.

It is to be emphasized here that the current description is not limited to two-dimensional HNNs and NHNNs, but can be generalized to greater than two dimensions. In the case of a three-dimensional networks, such as crystals, glassy water or silica, each node has four connections; hence, increasing the complexity of the neural network. Because rings, that are separated in two dimensions (2D), may be connected in higher dimensions, the possible pathways for the flow of information may increase. When the network architecture is based on materials with directional bonds, the flow of information can be assumed to follow the inner directionality of the network.

### Hyperuniform Connectivity

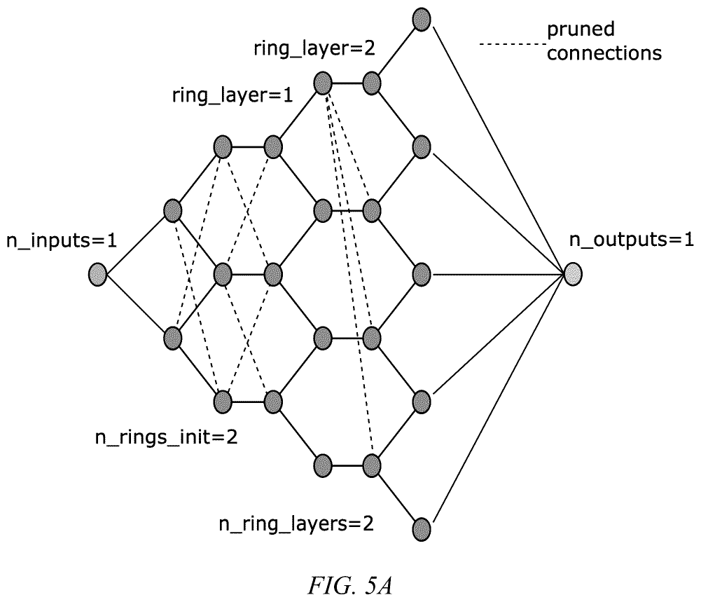

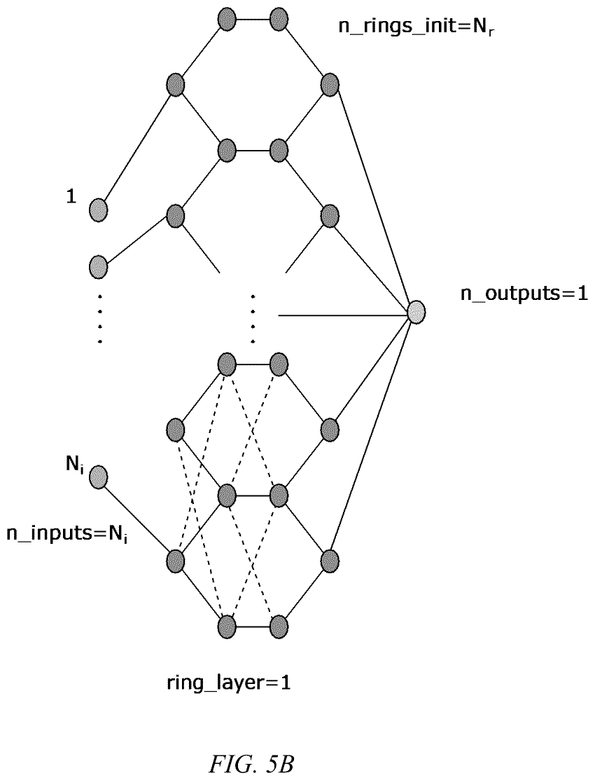

FIG. 5A is an example of a hyperuniformly connected network, in accordance with an example embodiment. It is obtained by pruning a fully-connected network. Different algorithms can be employed for creating deep models. In addition, note that nearly hyperuniform connections can be constructed as well. An exemplary model was tested on a simple regression problem that does not require many layers; therefore, a hyperuniform connectivity was used.

### Shallow Learning

A regression test was performed on predicting a smooth signal from past noisy data. In order to compare sparse connectivity vs. full connectivity, connections were switched off and on, respectively, and the relative error after training was measured. By doing so, the number of weights needed to be optimized during the training can be changed. The hyperparameters were otherwise the same, i.e., the number of epochs and the learning rate of 1×10⁻³. A Tanh activation function was used for the nodes and an Adam optimization algorithm was used for learning. The error vs. the number of weights was then plotted for each architecture (keeping the random seed constant). For the sake of completeness, a network consisting of only one hidden layer was also considered.

FIG. 5B illustrates a fully-connected neural network undergoing pruning to generate a (nearly) hyperuniform network, in accordance with an example embodiment. In a fully-connected network, every node connects to the nodes in another layer. In a (nearly) hyperuniform network, these links are pruned (dashed lines) to follow a particular connectivity. Thus, to create a (nearly) hyperuniform network, a fully-connected neural network is subjected to pruning until the (nearly) hyperuniform network is derived. In the example neural network of FIG. 5B, when the input is set to “sparse,” the number of nodes equals the number of initial rings; that is, n_inputs=n_rings_init, and each input goes only to one ring. Otherwise, all input features go to all rings.

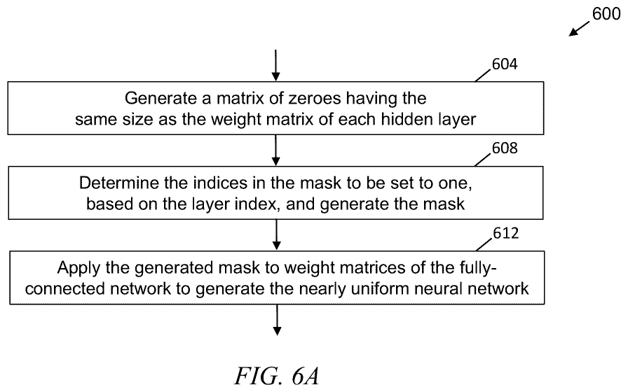

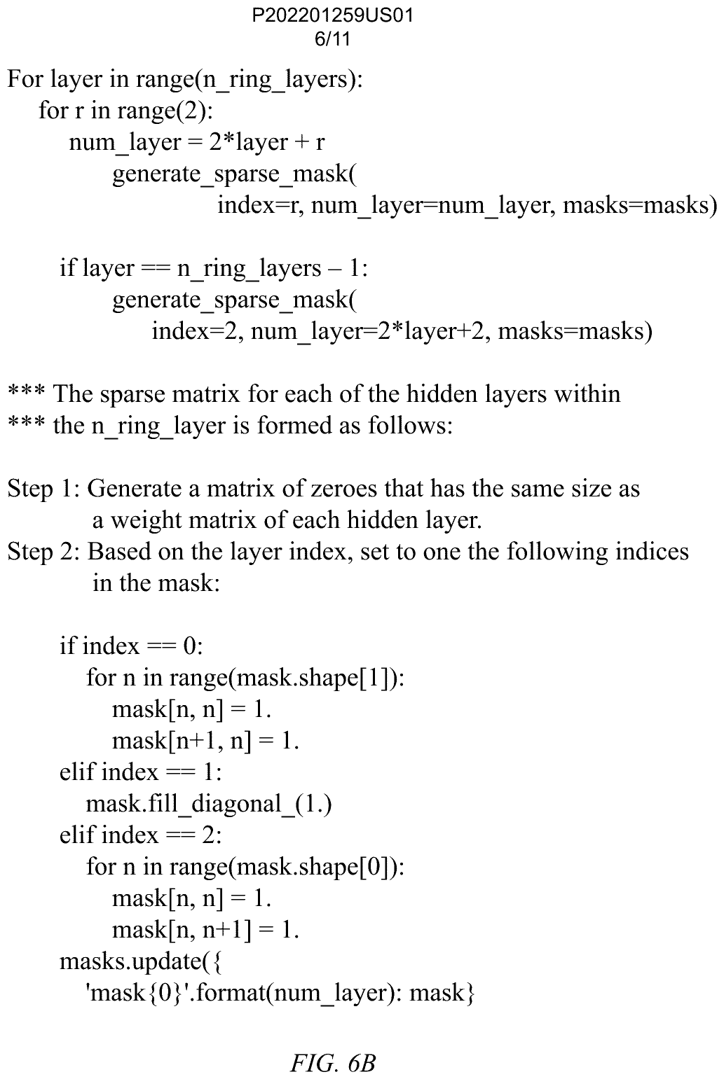

FIG. 6A is a flowchart 600 for generating a hyperuniform neural network, in accordance with an example embodiment. In one example embodiment, a matrix of zeroes having the same size as the weight matrix of each hidden layer is generated (operation 604). The indices in the mask to be set to one are determined, based on the layer index, and the mask is generated (operation 608). The generated mask is applied to weight matrices of a fully-connected network to generate the uniform neural network (operation 612).

FIG. 6B is high-level computer code for generating a hyperuniform neural network, in accordance with an example embodiment. To obtain a honeycomb structure of a uniform neural network from a fully connected network, sparse masks are created for a given number of ring layers (n_ring_layers) and applied to neural network weights. The function of FIG. 6B is derived from original code written in Python. Applying the above mask to weight matrices of the fully-connected network results in the honeycomb structure of the hyperuniform neural network. FIGS. 6A and 6B thus present techniques to generate hyperuniform networks.

Predicting a Signal from Past Noisy Data

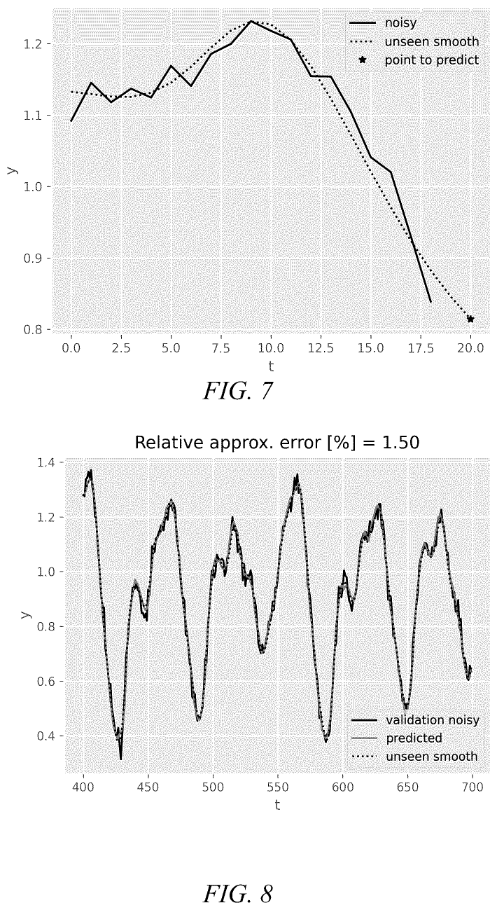

Consider the prediction of the 20^{th} (smooth) point from 19 given points of a noisy signal. The trained filtering window is slid along the signal to uncover the smooth trend. (The smooth data is not seen during the training.) FIG. 7 shows the results of the regression task, where 19 noisy points are being fed (obtained by adding noise to the smooth data) and the last, 20th point, that follows the smooth (unseen during the training) trend is predicted. FIG. 8 shows the results of applying the trained filter to the noisy signal, including the input noisy (validation) data, the (unseen) smooth ground truth, and the (predicted) output of the trained filter with relative approximation error of 1.6%, as labeled therein.

### Regression

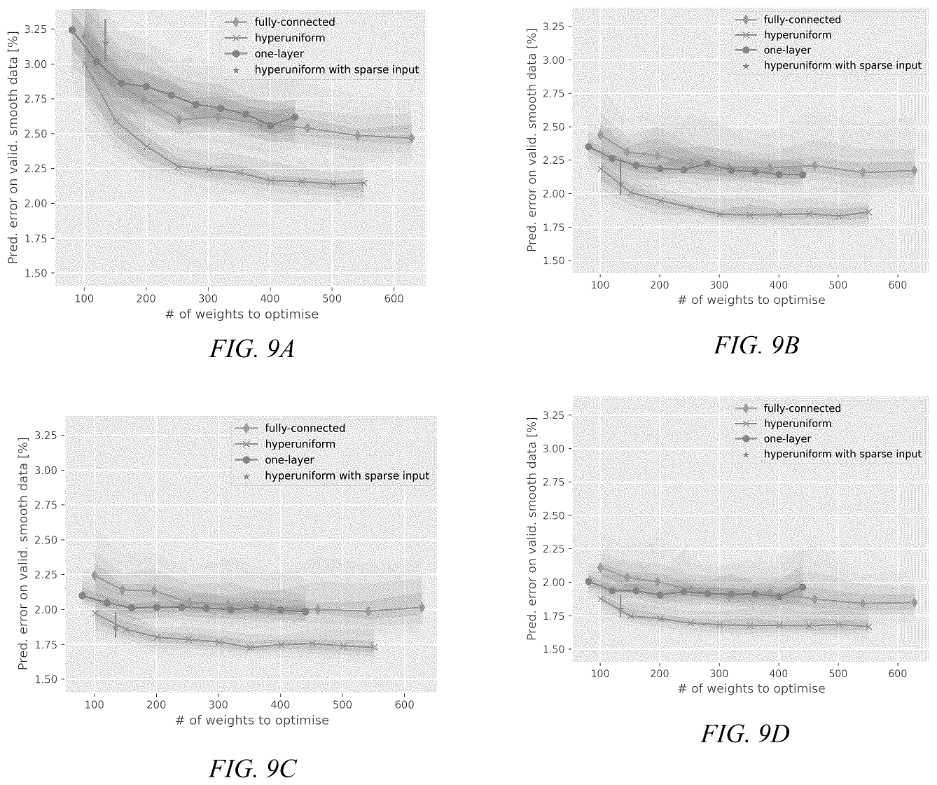

FIGS. 9A-9D are graphs of prediction error vs. the number of weights to optimize with a Tanh activation for a fully-connected neural network, a hyperuniform neural network, and a one layer neural network, in accordance with an example embodiment. In this case, the fully-connected network has the same number of hidden layers as an HNN. FIGS. 9A-9D are based on 100 epochs, 200 epochs, 300 epochs, and 400 epochs, respectively. With a hyperuniform neural network, a lower error can be obtained than for a fully-connected neural network having six times more weights. (Note: The plots show median+percentiles over ensemble of 100 different models for each setting (number of weights to optimize).)

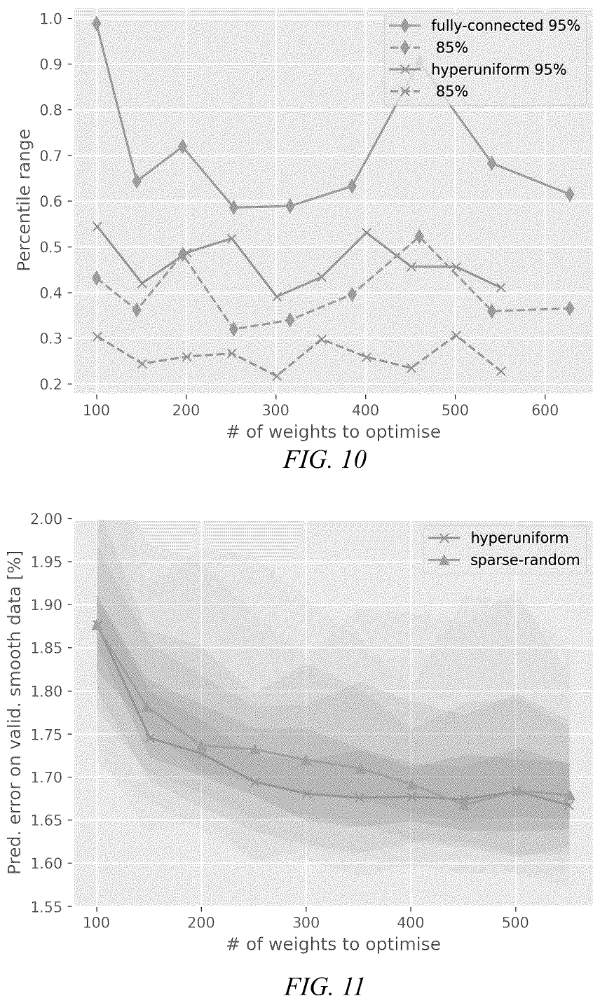

FIG. 10 is a plot of the 95% and 85% percentile range for fully-connected and hyperuniform networks based on ensemble of 100 models (after 400 epochs). The hyperuniform network is also more stable than a fully-connected network. It can be seen that the hyperuniform network is more stable/has a lower variance.

### Random Pruning 1

FIG. 11 is a graph showing a comparison of the relative error obtained with the hyperuniform model and with 100 networks randomly pruned and without dead nodes, in accordance with an example embodiment. The “spare-random” distribution in the plot refers to the average over all 100 random networks. For both models, there are the same number of nodes in each layer and number of connections. Although, on average, hyperuniform and sparse-random configurations perform similarly, the hyperuniform network sits on the lower bound. It is worth considering that, given the low number of connections in the hyperuniform networks, some of the 100 networks with random permutations have, by chance, connectivity very close to the hyperuniform one. In this particular instance, it is difficult to showcase the benefit of the hyperuniform structure as other networks will, occasionally, randomly end up having a similar topology.

### Random Pruning 2

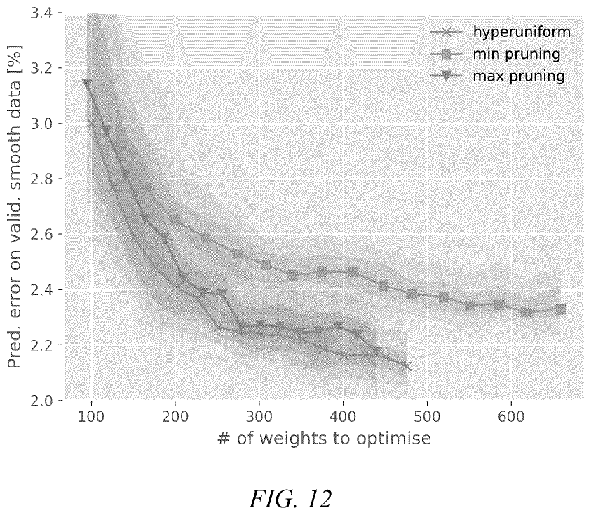

The hyperuniform connectivity aims at maximizing the efficiency with a minimal number of connections needed to perform a task. If a similar level of sparsity is enforced but with random connectivity, much difference in accuracy is not expected. However, if the number of connections pruned is smaller or larger, the hyperuniform connectivity is seen to perform better. FIG. 12 shows the relative error obtained from sparse models with less and more connections than the hyperuniform architecture. In the maximum pruning case, the number of connections is kept equal to the highest dimension of the weight matrix for inner layers. In one example embodiment, it is noted that having dead nodes is avoided. It can be seen that maximum pruning, which considers networks with often less connections than the hyperuniform, performs worse than the hyperuniform network. The minimal pruning case, obtained by randomly removing only a small number of connections for hidden layers, gives better accuracy than a fully-connected network, but still performs worse than the hyperuniform model.

Thus, one or more embodiments provide a sparse topology for feedforward neural networks performing classification, regression, and correlations at different scales, where the connectivity is based on hyperuniform or nearly hyperuniform topologies found in materials science. Aspects can be expanded to cover sparse attention in self-attention networks such as transformers using the hyperuniform and nearly hyperuniform topology.

Given the discussion thus far, it will be appreciated that, in general terms, an exemplary method, according to an aspect of the invention, includes the operations of generating a sparse topology for a feedforward neural network, where connectivity is based on a substantially hyperuniform topology; training the feedforward neural network with the sparse topology using a set of training data; and performing a processing task using the trained feedforward neural network.

In one example embodiment, the processing task comprises one of classification, regression, and correlations at different scales.

In one example embodiment, the processing task comprises connecting to a medical imaging device via a network module 115, obtaining a medical image, processing the medical image using the trained feedforward neural network, and treating a patient based on results of the processing of the image.

In one example embodiment, the processing task comprises obtaining financial information via a network module 115, processing the financial information using the trained feedforward neural network, and detecting and mitigating financial fraud based on results of the processing of the image.

In one example embodiment, the performing the processing task further comprises feeding input elements of an input vector into a first set of hidden nodes of the trained feedforward neural network, applying a linear transformation by each of the set of hidden nodes to a corresponding input element or corresponding input vector, applying an activation function to a result of the linear transformation, and obtaining an output value.

In one example embodiment, a layer of the sparse topology comprises a set of nodes connected in one direction and an output value of a node of a given layer is an input value of one or more subsequent nodes of the given layer or another layer.

In one example embodiment, nodes in the same layer of the trained feedforward neural network have the same activation function.

In one example embodiment, the sparse topology comprises a network of ring configurations of nodes in two dimensions or surface configurations of nodes in greater than two dimensions, the ring configurations and surface configurations having variable connectivity between the corresponding nodes, and wherein a copy of information flows over a top of a given ring configuration or a given surface configuration of the trained feedforward neural network and through a bottom of the given ring or the given surface to meet at a rightmost corner of the given ring or the given surface.

In one example embodiment, at least one ring configuration of nodes of the trained feedforward neural network has a different number of nodes than another configuration ring of nodes of the trained feedforward neural network.

In one example embodiment, bidirectional connections between two nodes of the trained feedforward neural network enable an exchange of information that allows for a mixing of information that reaches different regions of the neural network.

In one example embodiment, a final layer of the trained feedforward neural network has one or more nodes with linear activation for a regression or logistic function for binary classification.

In one example embodiment, in the operation of generating the sparse topology for the feedforward neural network, the sparse topology comprises a network of surface configurations of nodes in greater than two dimensions.

In one aspect, a non-transitory computer readable medium comprises computer executable instructions which when executed by a computer cause the computer to perform the method of generating a sparse topology for a feedforward neural network, where connectivity is based on a substantially hyperuniform topology; training the feedforward neural network with the sparse topology using a set of training data; and performing a processing task using the trained feedforward neural network.

In one aspect, an apparatus comprises a memory and at least one processor, coupled to the memory, and operative to perform operations comprising generating a sparse topology for a feedforward neural network, where connectivity is based on a substantially hyperuniform topology; training the feedforward neural network with the sparse topology using a set of training data; and performing a processing task using the trained feedforward neural network.

In one example embodiment, the processing task is one of a classification task and a regression task (i.e., a classification task or a regression task). Non-limiting examples of a classification task include image recognition and an analysis of medical data for tumor classification, detection of anomalies in computer network traffic or operations of various assets, defect detection of manufacturing processes (e.g. semiconductor and automobile manufacturing), and the like. Non-limiting examples of a regression task include financial predictions, weather prediction, and model predictive control and failure prediction of engineering systems including chemical/biological reactors, blast furnaces, aluminum smelters, compressors, and the like.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

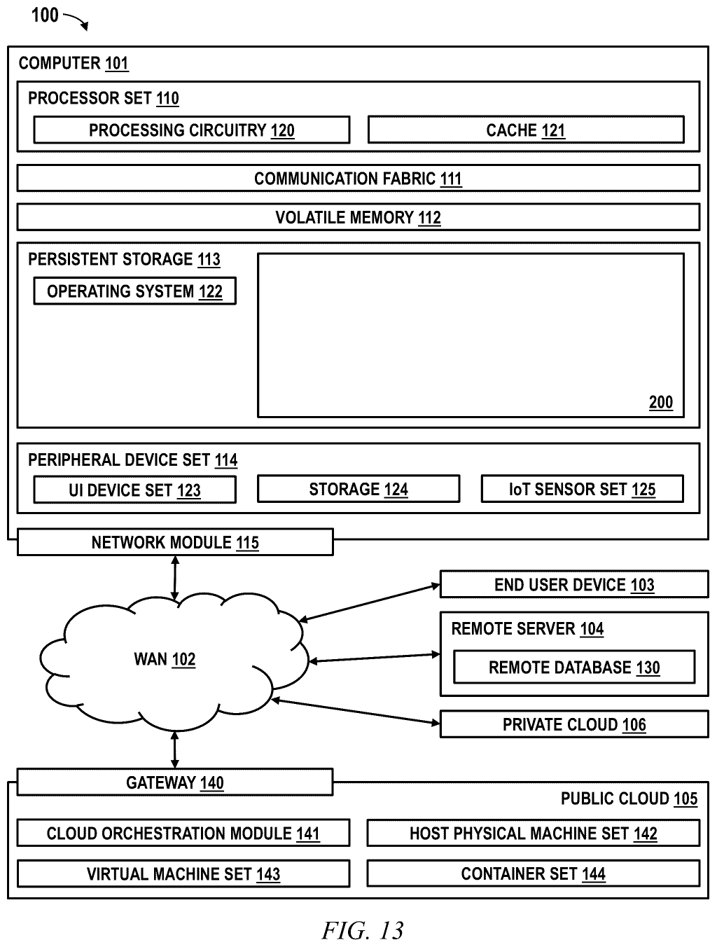

Refer now to FIG. 13.

Computing environment 100 contains an example of an environment for the execution of at least some of the computer code involved in performing the inventive methods, such as hyperuniform or nearly hyperuniform neural network 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments of the invention, or elements thereof, can thus be implemented in the form of an apparatus including a memory and at least one processor that is coupled to the memory and operative to perform exemplary method steps. FIG. 2 depicts a computer system that may be useful in implementing one or more aspects and/or elements of the invention

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
generating a sparse topology for a feedforward neural network, where connectivity is based on a substantially hyperuniform topology;
training the feedforward neural network with the sparse topology using a set of training data; and
performing a processing task using the trained feedforward neural network.

2. The method of claim 1, wherein the processing task comprises one of classification, regression, and correlations at different scales.

3. The method of claim 1, wherein the processing task comprises connecting to a medical imaging device via a network module, obtaining a medical image, processing the medical image using the trained feedforward neural network, and treating a patient based on results of the processing of the image.

4. The method of claim 1, wherein the processing task comprises obtaining financial information via a network module, processing the financial information using the trained feedforward neural network, and detecting and mitigating financial fraud based on results of the processing of the image.

5. The method of claim 1, wherein the performing of the processing task comprises:
feeding input elements of an input vector into a first set of hidden nodes of the trained feedforward neural network;
applying a linear transformation by each of the set of hidden nodes to a corresponding input element or corresponding input vector;
applying an activation function to a result of the linear transformation; and
obtaining an output value.

6. The method of claim 1, wherein a layer of the sparse topology comprises a set of nodes connected in one direction and an output value of a node of a given layer is an input value of one or more subsequent nodes of the given layer or another layer.

7. The method of claim 6, wherein nodes in a same layer of the trained feedforward neural network have a same activation function.

8. The method of claim 1, wherein the sparse topology comprises a network of ring configurations of nodes in two dimensions or surface configurations of nodes in greater than two dimensions, the ring configurations and surface configurations having variable connectivity between the corresponding nodes, and wherein a copy of information flows over a top of a given ring configuration or a given surface configuration of the trained feedforward neural network and through a bottom of the given ring or the given surface to meet at a rightmost corner of the given ring or the given surface.

9. The method of claim 1, wherein at least one ring configuration of nodes of the trained feedforward neural network has a different number of nodes than another configuration ring of nodes of the trained feedforward neural network.

10. The method of claim 9, wherein bidirectional connections between two nodes of the trained feedforward neural network enable an exchange of information that allows for a mixing of information that reaches different regions of the neural network.

11. The method of claim 1, wherein a final layer of the trained feedforward neural network has one or more nodes with linear activation for a regression or logistic function for binary classification.

12. The method of claim 1, wherein, in the operation of generating the sparse topology for the feedforward neural network, the sparse topology comprises a network of surface configurations of nodes in greater than two dimensions.

13. A non-transitory computer readable medium comprising computer executable instructions which when executed by a computer cause the computer to perform the method of:
generating a sparse topology for a feedforward neural network, where connectivity is based on a substantially hyperuniform topology;
training the feedforward neural network with the sparse topology using a set of training data; and
performing a processing task using the trained feedforward neural network.

14. An apparatus comprising:
a memory; and
at least one processor, coupled to said memory, and operative to perform operations comprising:
generating a sparse topology for a feedforward neural network, where connectivity is based on a substantially hyperuniform topology;
training the feedforward neural network with the sparse topology using a set of training data; and
performing a processing task using the trained feedforward neural network.

15. The apparatus of claim 14, wherein the performing the processing task comprises:
feeding input elements of an input vector into a first set of hidden nodes of the trained feedforward neural network;
applying a linear transformation by each of the set of hidden nodes to a corresponding input element or corresponding input vector;
applying an activation function to a result of the linear transformation; and
obtaining an output value.

16. The apparatus of claim 14, wherein a layer of the sparse topology comprises a set of nodes connected in one direction and an output value of a node of a given layer is an input value of one or more subsequent nodes of the given layer or another layer.

17. The apparatus of claim 14, wherein the sparse topology comprises a network of ring configurations of nodes in two dimensions or surface configurations of nodes in greater than two dimensions, the ring configurations and surface configurations having variable connectivity between the corresponding nodes, and wherein a copy of information flows over a top of a given ring configuration or a given surface configuration of the trained feedforward neural network and through a bottom of the given ring or the given surface to meet at a rightmost corner of the given ring or the given surface.

18. The apparatus of claim 14, wherein at least one ring configuration of nodes of the trained feedforward neural network has a different number of nodes than another configuration ring of nodes of the trained feedforward neural network.

19. The apparatus of claim 18, wherein bidirectional connections between two nodes of the trained feedforward neural network enable an exchange of information that allows for a mixing of information that reaches different regions of the neural network.

20. The apparatus of claim 14, wherein, in the operation of generating the sparse topology for the feedforward neural network, the sparse topology comprises a network of surface configurations of nodes in greater than two dimensions.
